(19) United States
(12) Patent Application Publication
(10) Pub. No.: US 2025/0038963 A1
(43) Pub. Date: Jan. 30, 2025

(54) NETWORK PATH VERIFICATION

(71) Applicant: BRITISH TELECOMMUNICATIONS PUBLIC LIMITED COMPANY, LONDON (GB)

(72) Inventors: Jonathan ROSCOE, London (GB); Fadi EL-MOUSSA, London (GB)

(21) Appl. No.: 18/716,567

(22) PCT Filed: Nov. 21, 2022
(86) PCT No.: PCT/EP2022/082649

§ 371 Date: Jun. 5, 2024

(30) Foreign Application Priority Data
Dec. 8, 2021 (GB) 2117683.9

(51) Int. Cl. H04L 9/08; H04L 9/00; H04L 9/32

(52) U.S. Cl. CPC H04L 9/0825; H04L 9/3247; H04L 9/50

(57) ABSTRACT

A method of recording a network path in a network that includes a plurality of nodes is provided. The network path includes a source node, a destination node, and one or more intermediate nodes. The method includes receiving, at an intermediate node, a transaction, the transaction including a first cryptographic object and signatures of at least a subset of any preceding intermediate nodes in the network path; generating, by the intermediate node, a second cryptographic object based on the first cryptographic object; updating, by the intermediate node, the transaction with a signature of the intermediate node and with the second cryptographic object; and sending, from the intermediate node, the transaction to a succeeding node in the network path. Each cryptographic object allows the transaction to be verified up to the node that generated that cryptographic object. Nodes and a system for implementing the method are also provided.

### PRIORITY CLAIM

The present application is a National Phase entry of PCT Application No. PCT/EP2022/082649, filed Nov. 21, 2022, which claims priority from GB Application No. 2117683.9 filed Dec. 8, 2021, each of which hereby fully incorporated herein by reference.

### TECHNICAL FIELD

This disclosure relates to networking methods. In particular, this disclosure relates to methods, devices and systems for recording and verifying a network path in a network comprising a plurality of nodes.

### BACKGROUND

Data networks usually split the data they carry into small units known as packets. Each packet carries a number of headers that are defined by various communication protocols.

The great majority of packets carried by commercial networks nowadays are so-called TCP-IP packets. TCP is the Transmission Control Protocol. This ensures the data arrives reliably (in the correct order and without errors) and is sent to the correct application on the receiver. IP is the Internet Protocol. This ensures the packets are correctly transmitted from the source to the destination. In theory IP is a connectionless protocol, which means each data packet could take a different route to reach the destination.

The static architecture of traditional networks is decentralized and complex while current networks require more flexibility and easy troubleshooting. To address this, technologies such as software-defined networking (SDN) provide an approach to network management that enables dynamic, programmatically efficient network configuration in order to improve network performance and monitoring. SDN attempts to centralize network intelligence in one network component by disassociating the forwarding process of network packets (data plane) from the routing process (control plane). The control plane consists of one or more controllers, which are considered the brain of the SDN network where the whole intelligence is incorporated.

Network slicing is a mechanism that allows multiplexing of network resources using the SDN technology, where the network can duplicate services and resources in the network using SDN and network functions virtualization (NFV) to allow the implementation of flexible and scalable network slices on top of a common network infrastructure, Presently, SDN-NVF offers routing protocols such as LLDP that routes traffic through a specific path based on the services that are registered by the customer, but it does not guarantee that the service has been applied to that customer's traffic. Similar issues exist with other networking technologies.

### SUMMARY

Accordingly, a method of verifying the path taken by, or services applied to, a data packet sent over a network is desirable.

According to a first aspect, a method of recording a network path in a network that comprises a plurality of nodes is provided. The network path comprises a source node, a destination node, and one or more intermediate nodes. The method comprises receiving, at an intermediate node, a transaction, the transaction comprising a first cryptographic object and signatures of at least a subset of any preceding intermediate nodes in the network path; generating, by the intermediate node, a second cryptographic object based on the first cryptographic object; updating, by the intermediate node, the transaction with a signature of the intermediate node and with the second cryptographic object; and sending, from the intermediate node, the transaction to a succeeding node in the network path. Each cryptographic object allows the transaction to be verified up to the node that generated that cryptographic object.

By including a cryptographic object that is updated by at least some nodes along a network path in a transaction, information about that network path can be securely received and recorded. The use of a cryptographic object that allows the transaction to be verified means that details of the network path cannot be faked, and that, for example, a node that a transaction was not routed through could not claim to have routed the transaction. This is because such a claim would not be verified by the cryptographic object.

In one example, the first and second cryptographic objects are hashes.

Hashes provide a computationally simple cryptographic object that can easily be generated by each node and stored as appropriate. They can be verified based upon whether the hash can be recreated or not.

When the cryptographic object is a hash, generating, by the intermediate node, a second cryptographic object based on the first cryptographic object may comprise hashing the first cryptographic object with a signature of the intermediate node.

A signature of an intermediate node can be verified but not faked. Generating the second cryptographic object by hashing the first cryptographic object with a signature of the intermediate node means that it can be assured that that intermediate node was in fact a part of the network path. This is because the signature verifies that the intermediate node did in fact sign (i.e., a node that was not in the network path cannot be fraudulently added to the list as its signature cannot be forged). Furthermore, the second cryptographic object being a hash of the first cryptographic object and the signature of the intermediate node allows verification of each node that modifies the transaction in this manner. This is because if an intermediate node that has updated the transaction in this manner is removed from the network path, the hash will not be able to be recreated based on the fraudulent network path.

In another example, generating, by the intermediate node, a second cryptographic object based on the first cryptographic object comprises encrypting the first cryptographic object using a private key of the intermediate node, such that it can be decrypted using a corresponding public key of the intermediate node.

In this case, due to the encryption of the second cryptographic object, it cannot be tampered with. The network path can then be verified by applying, in reverse, the public keys of each node that has modified the transaction in this manner. If the network path has been fraudulently modified, the encrypted second cryptographic object will not be able to be successfully decrypted.

Optionally, the signatures of the at least a subset of any preceding intermediate nodes and/or the signature of the intermediate node are generated based on a private key of the respective node and are verifiable using a public key of the respective node.

The use of signatures generated in this manner ensures that the signatures can be verified but cannot be forged. This means that it can be determined, using the public key of a node, that that node did in fact sign the transaction.

In this case, the public key of each intermediate node that has signed the transaction may be included in the transaction with the signature of the respective intermediate node.

By including the public key in the signed transaction, for example as an identifier of a node, the signatures can be easily verified without having to further look up a public key corresponding to a signature of a node from another source.

Optionally, the transaction further comprises one or more network path requirements.

Including one or more network path requirements in the transaction allows verification, based upon the recorded network path, that the network path requirements were met.

Additionally, if the transaction comprises one or more network path requirements, the succeeding node may be determined based on the one or more network path requirements.

Determining the succeeding node based on the one or more network path requirements means that it can be ensured that the network path requirements are met. For example, a succeeding node that meets the one or more network path requirements can be chosen. Alternatively, a succeeding node that has neighbors to which a data packet can be subsequently passed to and that meets the one or more network path requirements can be chosen.

One way in which a succeeding node can be determined is by using a bloom filter.

The use of a bloom filter can be advantageous when the succeeding node is to be determined based on one or more network path requirements. This is because it provides a computationally low cost, fast and efficient method of finding a path that meets the network path requirements.

If the succeeding node is determined based on one or more network path requirements, for example using a bloom filter, the succeeding node may be determined such that it meets some or all of the network path requirements.

This advantageously ensures that the one or more network path requirements are met. Such network path requirements may be a requirement that each node meet certain requirements, or that at least a specified number of nodes meet certain requirements. Optionally, the one or more network path requirements may include any of: a node latency limit; a node geographical location requirement; a firewall requirement; a malware detection requirement; an intrusion detection requirement; and a deep packet inspection requirement.

Optionally, the signatures of preceding intermediate nodes in the network path are included in the transaction with information identifying an order of the preceding intermediate nodes in the network path.

Including the information identifying an order of the preceding intermediate nodes can advantageously enable easy reconstruction of the path taken, rather than just the nodes visited. Information could be provided through the arrangement of the nodes, such as in a list or table, or in another way, such as numbering each node.

Optionally, updating the transaction with the signature of the intermediate node comprises appending the signature of the intermediate node to a list of signatures of any preceding intermediate nodes, the list being ordered by the position of the intermediate nodes in the network path.

In this manner, the transaction can be easily updated and the order of the nodes recorded. This order can be verified using the cryptographic objects.

Optionally, the transaction is included in a header of a network packet being sent via the network.

Including the transaction in a header makes it straightforward for the nodes to locate and modify the transaction as described above without any modification of the contents of the network packet.

For example, the method may be implemented in layer 2 or layer 3 of the Open Systems Interconnection (OSI) model.

Optionally, the method further comprises receiving, at the source node, a message request to send a message from the source node to the destination node over the network; generating, by the source node, a transaction comprising the first cryptographic object based on a signature of the source node; and sending, from the source node, the transaction to an intermediate node.

By creating the first cryptographic object based on a signature of the source node, the method ensures that the path can be verified back to, and including, the source node. Having the first cryptographic object based on a signature of the source node ensures that the transaction is genuine and could only have come from the source node, as the signature of the source node cannot be forged.

Optionally, the first cryptographic object is further based on one or more message parameters and/or one or more network path requirements.

Having the first cryptographic object also based on one or more message parameters, one or more network path requirements, or both, means that when the cryptographic object is verified then the message parameters and/or network path requirements will also be verified. Compliance with the network path requirements can also easily be checked against the nodes in the network path.

Optionally, receiving, at an intermediate node, a transaction, the transaction comprising a first cryptographic object and signatures of at least a subset of any preceding intermediate nodes in the network path; generating, by the intermediate node, a second cryptographic object based on the first cryptographic object; updating, by the intermediate node, the transaction with the signature of the intermediate node and with the second cryptographic object; and sending, from the intermediate node, the transaction to a succeeding node in the network path are performed iteratively for each intermediate node in the network path.

Performing these operations iteratively for each intermediate node, not just at one intermediate node or a subset of the intermediate nodes along a network path, means that the entire path can be verified. This means that each node in the network path is known, and that no nodes that were not in the network path can be represented as being in the network path, but that also no nodes can be removed from the network path. Furthermore, such a method allows verification that a certain class of node was not used. Optionally, the method further comprises receiving, at the destination node, when the succeeding node in the network path is the destination node, the transaction; generating, by the destination node, a final cryptographic object based on the second cryptographic object and further based on a signature of the destination node; updating, by the destination node, the transaction with the signature of the intermediate node and with the final cryptographic object; and storing the transaction.

Storing a final cryptographic object allows, at a later point in time, the network path to be verified. This can be particularly important for showing or determining regulatory or contractual compliance. It can be particularly advantageous to store the network path requirements in the final cryptographic object (for example, by basing, in part, the first cryptographic object on the network path requirements). This means that the network path requirements will be stored along with the network path itself, in a cryptographically secure form that can be verified to ensure its integrity.

Optionally, the transaction is stored in a blockchain and/or a database.

Storing the transaction in a database can allow for quick and efficient access of the final cryptographic object. Furthermore, because the network path is verifiable with the final cryptographic object, even if stored in an unsecure database the network path cannot be faked because the cryptographic object cannot be faked, though other problems, such as deletion of the final cryptographic object, may exist.

Storing the transaction in a blockchain, on the other hand, can overcome such issues. The distributed nature of a blockchain means that the blockchain ledger cannot easily be modified, ensuring that the cryptographic object can be stored without risk of modification.

According to a second aspect, a node configured to perform methods according to the first aspect is provided.

According to a third aspect, a system comprising a plurality of nodes according to the second aspect, configured to perform methods according to the first aspect, is provided. According to a fourth aspect, a non-transitory computer readable medium having stored thereon a computer program that, when run on a node according to the second aspect or a system according to the third aspect, causes the node or system to perform methods according to the first aspect.

### BRIEF DESCRIPTION OF THE DRAWINGS

This disclosure will be further described, by way of example only, with reference to the accompanying drawings, in which:

FIG. 1 illustrates a network comprising a plurality of nodes.

FIG. 2 illustrates a network path through the network of FIG. 1.

FIG. 3 illustrates a method according to aspects of the disclosure.

FIG. 4 illustrates further operations of a method according to aspects of the disclosure.

FIG. 5 illustrates further operations of a method according to aspects of the disclosure.

FIG. 6 illustrates a transaction for use with aspects of the disclosure.

FIG. 7 illustrates how a transaction is updated according aspects of the disclosure.

### DETAILED DESCRIPTION

Embodiments and related technology helpful for understanding and implementing the embodiments will now be described with reference to the Figures. The same or similar reference numerals are used to refer to the same or similar components across different Figures.

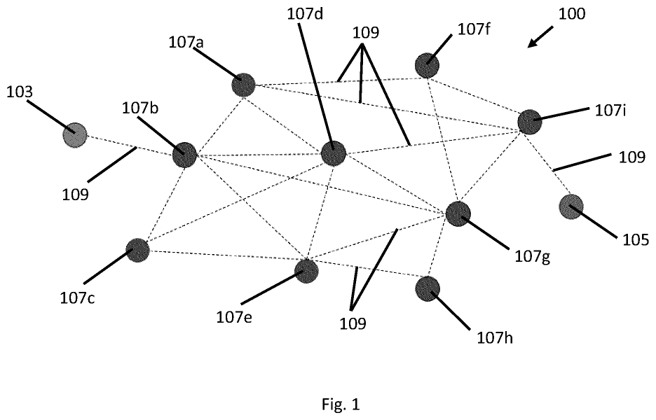

FIG. 1 illustrates an exemplary network. The network 100 comprises a plurality of nodes 103, 105, 107. Each node is connected to one or more other nodes via connections, represented by dashed lines, such as connections 109. Messages can be sent across the network 100 from one node, a sender or source node 103, to another node, a destination or final node 105 via one or more intermediate nodes 107. There need be no intrinsic difference between the source node 103, destination node 105 and intermediate nodes 107. Rather, these are just labels that relate to a node's position along a network path. A node may be the source node 103 for one message, an intermediate node 107 for another message and a destination node 105 for yet a different message.

A message can be sent as one or more packets (also referred to as data packets) across the network 100 in individual hops between adjacent or neighboring nodes 103, 105, 107. As used herein, two nodes are considered adjacent or neighboring if they are connected to each other by a connection 109. Accordingly, packets can be sent between neighboring pairs of nodes 103, 105, 107 along connections 109 until they reach their destination. It will be understood that a packet could take multiple paths through the network 100, and that constituent packets of a message split into multiple packets may each take different paths through the network 100. Such network paths are also known as network slices.

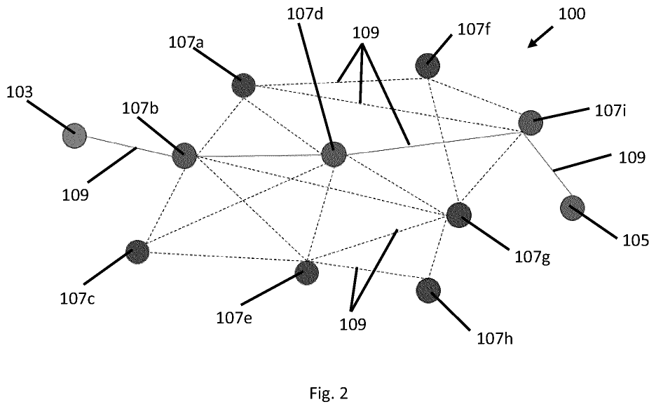

For example, if a message is sent from source node 103 intended for destination node 105, a first packet may take a path from source node 103 to intermediate node 107b, then to intermediate node 107d, then to intermediate node 107i, and finally to destination node 105. Such a path is illustrated by the solid line in FIG. 2. A second packet may take a path from source node 103 to intermediate node 107b, then to intermediate node 107e, then to intermediate node 107g, then to intermediate node 107i, and finally to destination node 105. Generally, there is no way to distinguish or determine the path taken by a data packet.

Different nodes 103, 105, 107 may have different properties. For example, some nodes may provide low latency connections, whilst others may not. Some nodes may also provide other services, such as deep packet inspection, malware scanning, and intrusion detection. Accordingly, it can be important to be able to determine the path taken by a data packet so that it can be determined what services, if any, were applied to the data packet.

To enable the network path taken by a data packet to be recorded, and hence subsequently checked, a transaction comprising signatures of the intermediate nodes through which the packet passed and a cryptographic object can be used.

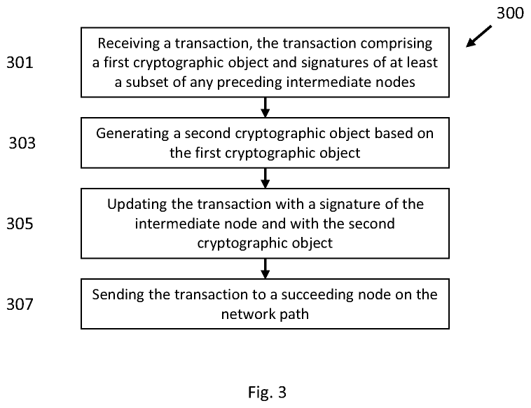

FIG. 3 illustrates a method 300 showing how a transaction is processed by an intermediate node to record the network path. The method 300 can be applied at an intermediate node.

At 301, the method comprises receiving a transaction. The transaction is received at the intermediate node from a preceding intermediate node or a source node in the network path. The transaction comprises a first cryptographic object and signatures of at least a subset of any preceding intermediate nodes in the network path. It is noted that if the transaction is received from the source node (i.e. the intermediate node is the first intermediate node in the network path) then the transaction will not include any signatures of previous intermediate nodes, though it may include a signature of the source node.

The first cryptographic object is an object that allows the transaction to be verified up to the node that generated that cryptographic object. That is, using the first cryptographic object, it can be verified that the transaction that is received is genuine and has not been altered, as discussed in more detail below. When, subsequently in the method, the intermediate node generates a second cryptographic object, this second cryptographic object then verifies the transaction up to the intermediate node that generated the second cryptographic object.

Two example suitable forms for the first cryptographic object are a hash or an encryption of information relating to the transaction. These two examples of suitable forms of the first cryptographic object will be explained in more detail below.

The signatures of the at least a subset of any preceding intermediate nodes (and optionally of the source node) in the network path are digital signatures. The digital signatures are based on a private key of the node signing the transaction, and can be verified using a corresponding public key of the respective node. This public key can be provided in the transaction, or otherwise looked up based on a node ID, The digital signatures cannot be forged, and so it can be ensured that a node that has signed the transaction did in fact handle the transaction. Furthermore, the signatures also provide non-repudiation, meaning that a node who's signature is in the transaction cannot claim to have not signed the transaction.

At 303, the intermediate node generates a second cryptographic object based on the first cryptographic object. The second cryptographic object should be of the same type as the first cryptographic object, and take the first cryptographic object as an input. In this manner, the first cryptographic object can be transformed into the second cryptographic object. The second cryptographic object allows verification that this transformation was performed by the intermediate node. By using the method iteratively for each intermediate node, then the entire network path can be verified. By way of example, when the second cryptographic object is a hash of the first cryptographic object and the signature of the intermediate node, then the second cryptographic object can be verified by recreating the hash. In another example, when the second cryptographic object is generated by encrypting the first cryptographic object using the private key of the intermediate node, the second cryptographic object can be verified by decrypting the second cryptographic object using the public key of the intermediate node.

Once the second cryptographic object has been generated, the transaction is then updated, at 305, with the second cryptographic object and a signature of the intermediate node. That is, the transaction is updated such that it includes a signature of the intermediate node and such that it includes the second cryptographic object. In some cases, the second cryptographic object can replace the first cryptographic object in the transaction, whilst in other cases the second cryptographic object may be added to the transaction without removing the first cryptographic object.

The signature is optionally included in the updated transaction in a manner that allows the order of the nodes in the network path that have signed the transaction to be determined. For example, the signatures may be presented in an ordered list from the signature of the first node to sign the transaction to the signature of the most recent node to sign the transaction. The intermediate node, when updating the transaction with its signature, may append its signature to the end of the list of signatures.

Once the transaction is updated, at 307 the transaction is then sent from the intermediate node to a succeeding node on the network path. That is, the transaction is sent to the next node in the network path.

The succeeding node may be predetermined, e.g., when the packet is prepared for transmission by the source node, or the succeeding node may be determined by the intermediate node.

The transaction may comprise one or more network path requirements, and the intermediate node may choose a node as the succeeding node based on the one or more network path requirements. For example, it may choose a node that meets the one or more network path requirements as the succeeding node. In other cases the succeeding node need not meet the one or more network path requirements, for example because they have previously been met by a preceding node. Whether or not each node is required to meet the one or more network path requirements may depend upon what the one or more network path requirements are, as will be discussed further below.

In some cases, including when the succeeding node is determined based on one or more network path requirements, the succeeding node may be determined by the intermediate node using a bloom filter for discovering suitable candidate nodes to be the succeeding node.

When implementing a bloom filter, a node knows whether it has not got a neighbor with a given property. This means the node will immediately be able to determine if it is a dead end—that is, the network path cannot reach the destination by passing through that node while meeting any network requirements. In this case the packet will be returned to the previous node and a new route can be determined.

The node will also know if it may have a neighbor with a given property, but it does not know which of its neighbors has that property. If this is the case, to determine a succeeding node, an intermediate node can query its neighboring nodes (the nodes that it is directly connected to) to determine whether any of those neighboring nodes themselves meet any of the network path requirements. Each of the intermediate node's neighbors will then respond to the query stating that either they meet the network path requirements or that they do not. The succeeding node can be determined as a node that meets the network path requirements and a packet, including the transaction, can be passed on to that node. This process is repeated, with the succeeding node then applying a bloom filter to determine the next succeeding node.

The use of a bloom filter in this manner can provide a computationally efficient way of determining a network path, which can adapt to different network configurations and does not require each node to store large databases of information about each of the other nodes on the network. However, it will be appreciated that other network discovery and path selection methods could be used.

Through method 300, a node in a network path can record its place in the network path in the transaction in a verifiable way, enabling confidence that the network path listed in the transaction was in fact the network path taken by a packet associated with the transaction. When each intermediate node performs method 300 in an iterative manner, with the second cryptographic object being generated by a first intermediate node becoming the first cryptographic object at the succeeding node downstream in the network path, a verifiable record of each intermediate node in the network path can be created.

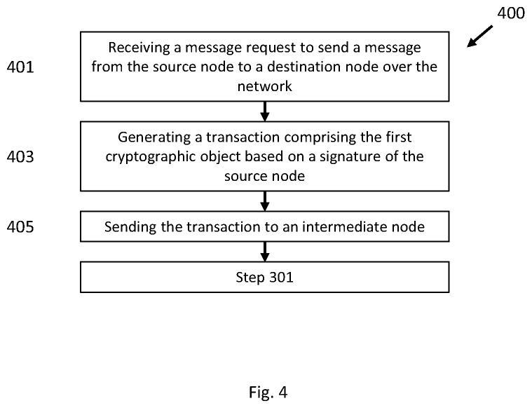

Whilst method 300 is performed by intermediate nodes in the network path, the source node from which a network packet originates may perform method 400, illustrated in FIG. 4, to generate an initial transaction that can be sent to, and received by, the first intermediate node in the network path. It will be appreciated that the operations of method 400, performed at the source node, have many similarities with the operations of method 300, performed at the intermediate nodes.

Method 400 begins at 401, whereby a message request is received at the source node.

This may be in the form of user input instructing the source node to send a message to a destination node over a network.

The source node may then prepare and format the message according to various protocols known in the art. Furthermore, for a particular data packet that is to be sent over the network, at 403 the source node generates a transaction. The transaction comprises a first cryptographic object based on a signature of the source node. This enables the origin of the transaction can be verified.

When the transaction has been generated, it is then sent to the first intermediate node in the network path at 405. The intermediate node may then receive the transaction, as discussed at 301 in relation to FIG. 3, and then proceed to process the transaction according to method 300.

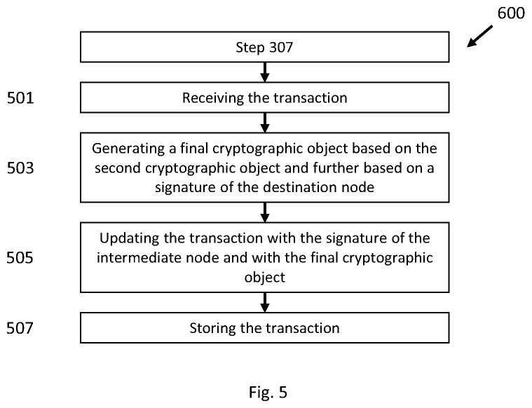

Similarly, the destination node may also perform differing (though again similar) operations to the source node and intermediate nodes. A method that can be performed by the destination node is set out in FIG. 5.

Method 500 begins, once the final intermediate node has sent the transaction to the destination node at 307 of method 300, by receiving the transaction at the destination node at 501.

Once the message is received, at 503 the destination node generates a final cryptographic object based on the second cryptographic object and also based on the signature of the destination node. The generation of the final cryptographic object may be the same, or substantially the same, as the generation of the second cryptographic object by an intermediate node discussed at 303 in method 300. This final cryptographic object allows verification that the message was received at the destination node, as well as any other nodes that also generated the cryptographic objects along the network path.

The transaction is then updated with the final cryptographic object and the signature of the intermediate node at 505 and the transaction is then stored at 507.

The transaction can be stored in a database. Because the transaction comprises the final cryptographic object and the signatures of the nodes that signed the transaction, the stored transaction can be verified even if the database is not secure. This means that any tampering or modification of the transaction, such as the addition or deletion of nodes, can be detected.

However, storing the transaction on a database does not necessarily allow a transaction to be restored to the correct version if it is modified, even if it is known that it has been modified. Similarly, it does not necessarily prevent the transaction from being deleted entirely from the database. One way that such problems can be overcome is by storing the transaction on a blockchain. Storing transactions on a blockchain means that, due to the use of a distributed ledger, it is very difficult for the transaction to be modified as such a modification would need to be reproduced by multiple devices that store the blockchain.

Hence, the use of a blockchain to store the transaction makes it difficult for the transaction to be modified once stored, and the use of the signatures and cryptographic objects within the transaction means that a transaction cannot be fraudulently created or modified prior to storage on the blockchain.

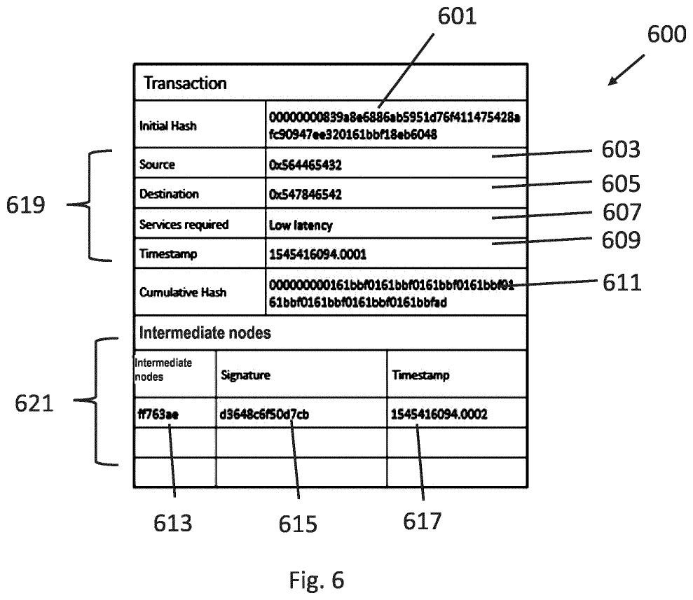

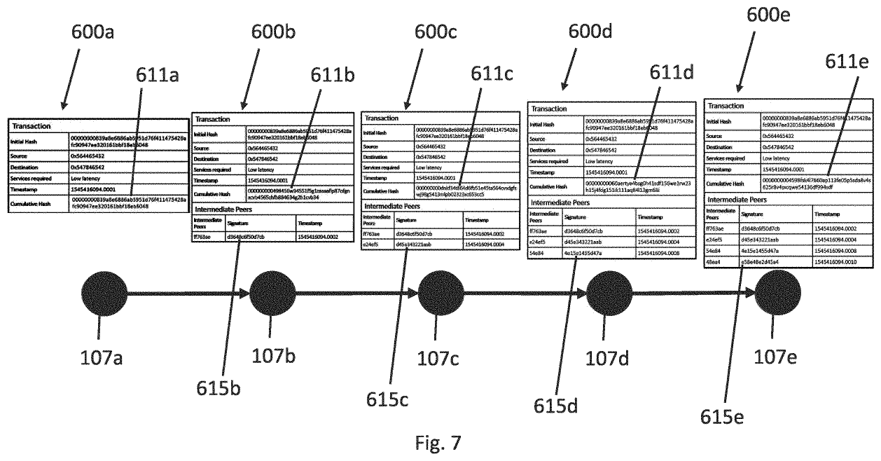

As discussed previously, examples of the cryptographic objects used in the methods of FIGS. 3 and 4 may be hashes or encrypted versions of parts of the transaction. An example whereby the cryptographic object is a hash will now be discussed with respect to FIGS. 6 and 7.

FIG. 6 illustrates an exemplary transaction 600 that generates the cryptographic object using a hashing algorithm.

The transaction 600 comprises an initial hash 601. The initial hash 601 is a hash of a signature of the source node and optionally one or more of the transaction parameters 619, in particular the network path requirement 607, in this case specifying that only “low latency” nodes can be used for routing the transaction. The initial hash 601 can, for example, be the first cryptographic object generated by the source node at 403 in method 400 of FIG. 4.

As well as the initial hash 601, the transaction 600 comprises transaction parameters 619. The transaction parameters specify the source node 603, the destination node 605, the network path requirements (e.g., services required) 607, and a timestamp 609 representing when the transaction 600 was generated. These need not necessarily be used in the generation of the first cryptographic object, but doing so can allow these parameters to be verified by hashing them at a later date and comparing the resultant hash with the initial hash 601.

The transaction 600 also comprises another cryptographic object, the cumulative hash 611. The cumulative hash 611 is generated by hashing the initial hash 601 with the signature 615 of intermediate node 613. The cumulative hash 611, therefore, acts as the second hash in method 300. The cumulative hash 611 is so called because it is updated in a cumulative, or iterative manner, as will be discussed further in relation to FIG. 7, by each intermediate node that signs the transaction 600.

Finally, in this example, the transaction 600 comprises a list 621 of the intermediate nodes that have signed the transaction 600, As illustrated, one intermediate node 613 has signed the transaction 600. The transaction 600 is signed using a digital signature 615 of the node 613, which uses its public key as its identifier. This advantageously enables easy verification of the signature using the public key. A timestamp 617 is also included to record the time at which the intermediate node 613 signed the transaction 600.

Turning to FIG. 7, this illustrates how a transaction 600 is updated by each node along a network path. FIG. 7 shows a network path from a source node 107a to a node 107e through intermediate nodes 107b, 107c and 107d. The transaction 600a, generated by the source node 107a, comprises a first cryptographic object generated by the source node 107a. This is the initial hash, described with respect to FIG. 6. It is noted that, as no intermediate nodes have yet signed the transaction 600a, the cumulative hash 611a is the same as the initial hash, though it is not necessary to have the hash duplicated.

The transaction 600a is sent to the first intermediate node 107b, for example in accordance with method 400. Once the transaction 600a is received by node 107b, the node takes the cumulative hash 611a (equal to the initial hash) as the first cryptographic object and uses it to generate a second cryptographic object by hashing it with its signature 615b, as per 303 of method 300. The transaction is then updated such that the second cryptographic object replaces the first cryptographic object in the cumulative hash field. That is, an updated cumulative hash 611b is generated by hashing the previous cumulative hash 611a with the signature 615b of node 107b, and this updated cumulative hash 611b then replaces the previous cumulative hash 611a in the transaction 600b. As well as updating the transaction 600b with the updated cumulative hash 611b, the node 107b signs the transaction 600b, adding its signature 615b to the transaction 600b. As discussed with respect to FIG. 6, this can be included with the public key of the node 107b and a timestamp. Accordingly, the transaction 600b is updated in line with 305 of method 300.

Once the transaction 600b has been updated with the updated cumulative hash 611b and the signature of the node 107b, the transaction 600b is sent from node 107b to the succeeding node in the network path, node 107c.

Node 107c then repeats the operations of method 300, as described above with respect to node 107b. The cumulative hash generated by node 107b is again updated by node 107c by hashing it with the signature 615c of node 107c to generate a new updated cumulative hash 615c which then replaces the previous cumulative hash 611b in the transaction 600c. The transaction 600c is also updated with the signature 615c of node 107c, in addition to the signature of node 107b. Node 107c then sends the transaction 600c to node 107d.

Node 107d again performs the operations of method 300, updating the transaction 600c with its signature 615d and an updated cumulative hash 611d to generate an updated transaction 600d, before sending the transaction 600d to node 107e.

Node 107e is illustrated as the final node in FIG. 7, though this need not be the case. Node 107e could again perform the operations of method 300 to generate an updated transaction 600e which it can send to further downstream nodes. However, when node 107e is the final node, it will instead perform the operations of method 500.

This involves generating updated transaction 600e in essentially the same manner as the previous nodes. The cumulative hash 611d from the received transaction 600d is updated by hashing it with the signature 615e of node 107e to generate an updated cumulative hash 611e, which is now the final cryptographic object of 503 in method 500.

Node 107e also signs the transaction 600e with its signature 615e, and so the transaction 600e is updated with the final cryptographic object (the updated cumulative hash 611e) and the signature 615e of node 107e. The updated, final transaction 600e is then stored, as per 507, for example, in a blockchain.

In some embodiments the hashing algorithm is publicly known in order to allow verification of the transaction at any stage. This known hashing algorithm is then used to hash the signatures in the transaction in the order they were applied to recreate the hash at that stage. For example, if the source node generates the first hash based on its signature only, then to verify the final hash stored in a blockchain firstly the signature of the source node is hashed, then the result of this is hashed with the signature of the first intermediate node that signed the transaction, then the result of this is hashed with the signature of the second intermediate node that signed the transaction, and so on. By doing this for each node that signed the transaction, including the destination node if necessary, the resulting hash can be compared to the stored hash to verify that they are identical. If they are, then the network path is verified. Otherwise, the network path cannot be verified and either the final, stored hash or the listed nodes have been modified.

An example of a suitable hashing algorithm would one from the Secure Hash Algorithm 2 (SHA-2) or the Secure Hash Algorithm 3 (SHA-3) families, such as the SHA-256 algorithm. Generally, a hashing algorithm with a low collision factor should be used.

Whilst FIGS. 6 and 7 relate to an example using a hashing algorithm, to generate the first and second cryptographic objects it is also possible to use an encryption algorithm. For example, a source node can generate a first cryptographic object by encrypting a piece of information, such as its signature, using its private key, and optionally other information such as network path requirements. This can be received by a first intermediate node as part of the transaction, and the first intermediate node can then encrypt the first cryptographic object, received from the source node, optionally along with its signature, using its private key. This then generates the second cryptographic object of method 300. Each subsequent node then encrypts the received (already encrypted) cryptographic object, optionally with its signature, using its private key.

The network path can then be verified by using the public key of each node (in some embodiments provided in the transaction with the signatures of each node, in the same manner as described with respect to FIG. 6). The final cryptographic object is decrypted by applying the public key of each node in reverse order to which it was encrypted (i.e., starting with the destination node and finishing with the source node). It will be apparent if the encrypted cryptographic object is tampered with as it will not be possible to decrypt it, and if the unencrypted list of signatures has been tampered with, the cryptographic object will not be able to be decrypted as the necessary public key will not be provided. Accordingly, if the final encrypted cryptographic object can be successfully decrypted, then the network path is verified. Otherwise, it is not. It will be appreciated that any cryptographically secure method of encryption may be used.

It is also noted that in the example of FIG. 7, the method 300 is applied at each intermediate node. That is, each intermediate node updated the cryptographic object and signed the transaction. This is necessary when the full network path needs to be checked, but in some cases this is not required.

The full network path may be required, for example, when it is necessary to check that a service or requirement was applied or met at each node, or when a certain class of node cannot be used. For example, if a low latency service is to be provided, with each node along a path having a maximum allowable latency, then it will be necessary for each node to be recorded along the network path so that it can be determined whether each node meets this latency requirement. In another example, nodes may have a geographic requirement. For example, nodes in a certain geographic area may be forbidden from being included in network paths, and so a record of each node along the network path will be required to determined compliance with this network path requirement.

On the other hand, some network path requirements may only need to be applied at a certain number of nodes along the network path, such as at one node. In other words, a network path requirement may be that a service is performed by at least one node along the network path. For example, network requirements that may not require application at each node, just a certain number of nodes, include deep packet inspection, intrusion detection and malware scanning.

It will be appreciated that any of the example network requirements described above may be combined with any of the other network path requirements.

It will also be appreciated that a “node”, as discussed herein, may be any physical or virtual device that can receive a message from a network and send a message to another node on the network, such as a router. In particular, they may be devices that operate in layer 2 or layer 3 of the Open Systems Interconnection (OSI) model, also known as the data link layer and network layer respectively. For example, the transactions could be implemented in a modification of the Layer 2 Tunnelling Protocol (L2TP) of the Internet protocol suit (TCP/IP) or of the Internet Protocol Security (IPsec) protocol suit which operates in OSI layer 3. IPsec allows route-based VPNs, ensuring that routes pass through certain interfaces based on destination address, whilst embodiments of this disclosure enhance this ensuring that the route is selected based on network path requirements and allowing verification of the route.

It will be understood by those skilled in the art that the apparatus of embodiments of this disclosure could be a general purpose device (or group of devices) having software arranged to provide an embodiment of the disclosure. Furthermore, any or all of the software used to implement embodiments can be contained on various storage mediums such as a floppy disc, CD-ROM, or magnetic tape so that the program(s) can be loaded onto one or more general purpose devices, or could be downloaded over a network.

1. A method of recording a network path in a network that comprises a plurality of nodes, the network path comprising a source node, a destination node, and one or more intermediate nodes, the method comprising:
receiving, at an intermediate node, a transaction, the transaction comprising a first cryptographic object and signatures of at least a subset of any preceding intermediate nodes in the network path;
generating, by the intermediate node, a second cryptographic object based on the first cryptographic object;
updating, by the intermediate node, the transaction with a signature of the intermediate node and with the second cryptographic object; and
sending, from the intermediate node, the updated transaction to a succeeding node in the network path;
wherein each of the first cryptographic object and the second cryptographic object allows the transaction or the updated transaction to be verified up to a node that generated that respective cryptographic object.

2. The method of claim 1, wherein the first cryptographic object and the second cryptographic object are hashes; and wherein generating, by the intermediate node, the second cryptographic object based on the first cryptographic object comprises hashing the first cryptographic object with a signature of the intermediate node.

3. The method of claim 1, wherein generating, by the intermediate node, the second cryptographic object based on the first cryptographic object comprises encrypting the first cryptographic object using a private key of the intermediate node, such that the first cryptographic object can be decrypted using a corresponding public key of the intermediate node.

4. The method of claim 1, wherein the signatures of the at least the subset of any preceding intermediate nodes or the signature of the intermediate node are generated based on a private key of the respective node and are verifiable using a public key of the respective node; and wherein the public key of each intermediate node that has signed the transaction is included in the transaction with the signature of the respective intermediate node.

5. The method of claim 1, wherein the transaction further comprises one or more network path requirements, and wherein the succeeding node is determined based on the one or more network path requirements.

6. The method of claim 5, wherein the succeeding node is determined using a bloom filter.

7. The method of claim 5, wherein the succeeding node is determined such that the succeeding node meets some or all of the network path requirements.

8. The method of claim 1, wherein the signatures of preceding intermediate nodes in the network path are included in the transaction with information identifying an order of the preceding intermediate nodes in the network path.

9. The method of claim 1, wherein the method further comprises:
receiving, at the source node, a message request to send a message from the source node to the destination node over the network;
generating, by the source node, a transaction comprising the first cryptographic object based on the signature of the source node; and
sending, from the source node, the transaction to an intermediate node.

10. The method of claim 1, wherein the first cryptographic object is further based on one or more message parameters or one or more network path requirements.

11. The method of claim 1, wherein the receiving, the generating, the updating, and the sending are performed iteratively for each intermediate node in the network path.

12. The method of claim 11, the method further comprising:
receiving, at the destination node when the succeeding node in the network path is the destination node, the transaction;
generating, by the destination node, a final cryptographic object based on the second cryptographic object and further based on a signature of the destination node;
updating, by the destination node, the transaction with the signature of the intermediate node and with the final cryptographic object; and
storing the transaction.

13. The method of claim 12, wherein the transaction is stored in a blockchain or a database.

14. A node configured to perform the method of claim 1.

15. A non-transitory computer readable medium having stored thereon a computer program that, when executed by a computer, causes the computer to perform the method of claim 1.

16. A system comprising a plurality of nodes configured to perform the method of claim 1.

17. The non-transitory computer readable medium of claim 15, wherein the computer resides in a node of a network.

18. The non-transitory computer readable medium of claim 15, wherein the node is one of plurality of nodes of a system.
